(19) United States
(12) Patent Application Publication
(10) Pub. No.: US 2004/0159163 A1
(43) Pub. Date: Aug. 19, 2004

(54) Sense of force imparting type input device

(75) Inventor: Mikio Onodera, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/677,699

(22) Filed: Oct. 2, 2003

(30) Foreign Application Priority Data
Oct. 11, 2002 (JP) 2002-298867

(51) Int. Cl. G01N 3/02

(52) U.S. Cl. 73/856

(57) ABSTRACT

An outer casing having an opening, an operating lever pivotably supported by a stick controller disposed in the outer casing, encoders for detecting the amount and the direction of the pivotal movement of the operating lever, motors for imparting a desired external force to the operating lever, and a monitor for displaying various menus and the current position of the operating lever are provided, a plurality of key switches arranged on the outer casing projecting from the opening of the outer casing so as to surround the operating lever, and the selecting operation of equipment selected from equipment menu options displayed on the monitor is determined by pressing the corresponding key switch.

### BACKGROUND OF THE INVENTION

1. Field of the Invention

The present invention relates to a sense of force imparting type input device having a force feedback function which imparts an external force such as feeling of resistance and thrust to an operator who pivots (swings) an operating lever according to the operating state of the operating lever and, more specifically, to a sense of force imparting type input device suitable to be used in on-vehicle control equipment.

2. Description of the Related Art

In recent years, there is proposed a sense of force imparting type input device with a force feedback function in which adjusting functions for on-vehicle control equipment such as air conditioners, audio sets, and navigation systems are all integrated into a single operating lever, and external forces such as feeling of resistance and thrust are imparted corresponding to the amount of operation and the direction of operation of the operating lever when selecting equipment or adjusting functions of the selected equipment by this operating lever, so that a feeling of operation is improved and reliable operability is ensured.

In the related art, a known sense of force imparting type input device of this type includes detecting means for detecting the amount of operation and the direction of operation of the operating lever, an actuator for imparting an external force to the operating lever, control means for controlling driving of actuator based on output signal supplied from the detecting means, and a monitor for displaying various menus and a current position of the operating lever (eg. Japanese Unexamined Published Patent Application No. 2002-189560 (P.4-6. FIG. 1))

The detecting means includes a converting unit for converting a pivotal movement of the operating lever into rotary movement of two revolving bodies that are orthogonal with respect to each other, and a detecting unit such as rotary encoder for converting the amount of rotation and the direction of rotation of these revolving bodies into electric signals, and the actuator is constructed of a motor. The control means receives a detected signal supplied from the detecting unit of the detecting means and supplies a desired control signal to the actuator based on the detected signal, and then displays the operating position (current position) of the operating lever on the monitor disposed, for example, on an instrument panel in a vehicle cabin. The control signals are signals corresponding to a feeling of operation imparted to the operating lever, and include several types such as a type which generates vibrations, or a type which varies the operating force. The upper end portion of the operating lever is projected from the outer surface in a vehicle cabin such as a center console box, and a plurality of key switches corresponding to the equipment menu indicating various equipment displayed on the monitor are arranged on the outer surface.

In the sense of force imparting type input device generally constructed as described above, the equipment menu indicating various equipment such as air-conditioner, audio set, and navigation system is displayed on the monitor as an initial screen, and when the operator presses one of key switches, the menu display screen is switched to a function screen for the equipment corresponding to the pressed key switch, so that the functions of the selected equipment can be adjusted by pivoting the operating lever. For example, when the operator selected the air conditioner by operating an optional key switch, functions such as temperature adjustment or airflow adjustment relating the air conditioner are displayed on the monitor, so that the temperature or the airflow can be adjusted by moving the cursor on the monitor by tilting the operating lever to a corresponding direction. In this case, the control means receives a detected signal supplied from the detecting means, and supplies a desired control signal to the actuator based on the detected signal, so that an external force according to the amount of operation and the direction of operation thereof is imparted to the operating lever. Therefore, the operator can recognize that the operating lever is operated to the intended direction by touch, and thus the feeling of operation is improved and the reliable operability is ensured.

In the case of the above-described sense of force imparting type input device in the related art, when selecting one of a plurality of pieces of equipment such as air-conditioner and audio sets for selecting a function, the operator is required to perform such troublesome operation as pressing one of key switches to select desired equipment from the equipment menu on the monitor, and then moving his/her hand to the operating lever and selecting the function of the selected equipment. Therefore, there exists a problem in that the usability is not good. In this case, although the group of key switches is disposed relatively near the operating lever every time, the group of key switches and the operating lever are disposed in the independent areas respectively. Therefore, when selecting a function of the desired equipment, the operator has to move his/her hand which pressed the key switch to the operating lever, and thus it is difficult to perform such operations in series by touch.

### SUMMARY OF THE INVENTION

In view of such circumstances in the related art, it is an object of the present invention to enable the operation to press the key switch for determining an option selected from the menu and the operation to pivot the operating lever to be performed continuously by touch and to provide a sense of force imparting type input device which is superior in operability and usability.

In order to achieve the above-described object, a sense of force imparting type input device according to the present invention includes an outer casing having an opening, an operating lever having a fulcrum inside the outer casing and being pivotably supported, detecting means for detecting the operating state of the operating lever, an actuator for imparting an external force to the operating lever, control means for controlling driving of the actuator based on output signals supplied from the detecting means, and a monitor for displaying various menus and the current position of the operating lever, wherein the outer casing is provided with a plurality of key switches arranged thereon so as to surround the operating lever, and the key switches are allocated to a plurality of pieces of equipment displayed as an equipment menu on the monitor, and selecting operation of equipment from the equipment menu is determined by pressing the key switches.

In the sense of force imparting type input device constructed as described above, when selecting desired equipment from the equipment menu displayed on the monitor for performing adjustment of a function of the selected equipment, the operator can perform the operation to press the key switch and the operation to pivot the operating lever continuously by touch with his/her hand supported on the outer casing. Therefore, the operability is enhanced and the usability is improved.

In the construction described above, all the key switches may have the same construction. However, it is preferable to differentiate the surface treatment and at least one of the operating force and the operating stroke from key to key. In this arrangement, the operator can recognize the difference among the key switches by touch.

In the construction described above, it is also preferable to arrange the key switches in a circular shape or in a square frame shape. Specifically, when the key switches are arranged into the square frame shape, the operator can recognize the position of the desired key switch by touch from the difference of the arranging direction of the key switches.

### BRIEF DESCRIPTION OF THE DRAWINGS

FIG. 1 is a drawing showing a construction of a sense of force imparting type input device according to an embodiment of the present invention;

FIG. 2 is a perspective view of a stick controller provided in the sense of force imparting type input device;

FIG. 3 is a lateral cross-sectional view of the stick controller;

FIG. 4 is a vertical cross-sectional view of the stick controller;

FIG. 5 is a cross sectional view showing the internal construction of an operating knob provided in the sense of force imparting type input device;

FIG. 6 is a plan view showing the operating knob and a group of the key switches;

FIG. 7 is a perspective view showing the operating knob and the group of key switches;

FIG. 8 is an explanatory drawing showing an example of operation of the operating knob;

FIG. 9 is an explanatory drawing showing the contents of display of a monitor;

FIG. 10 is an explanatory drawing showing the contents of display of the monitor;

FIG. 11 is an explanatory drawing showing the contents of display of the monitor; and

FIG. 12 is a perspective view showing a modification of the operating knob and the group of key switches.

### DESCRIPTION OF THE PREFERRED EMBODIMENTS

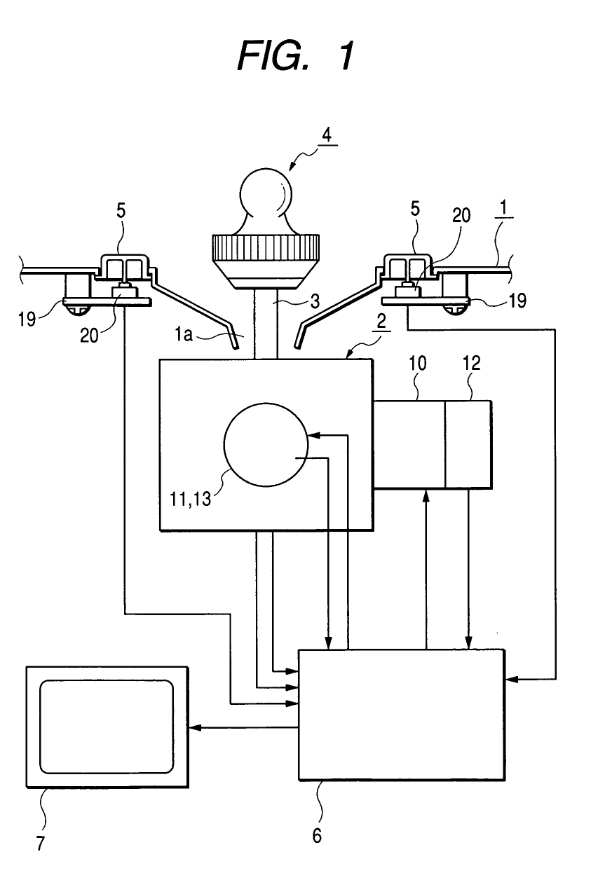

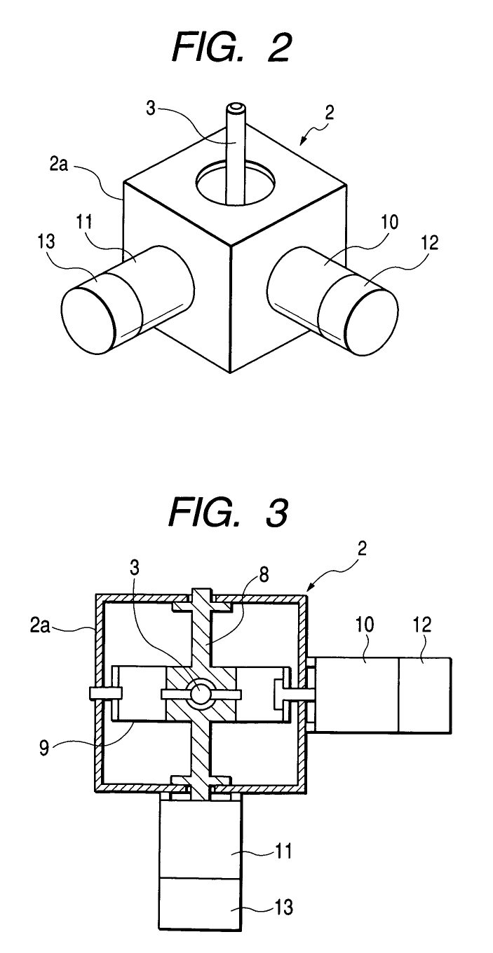

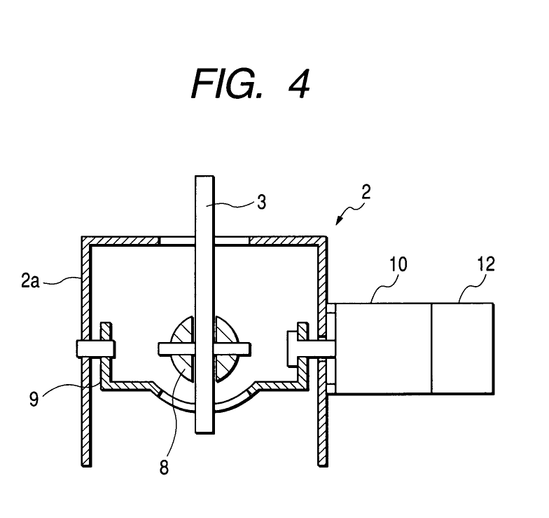

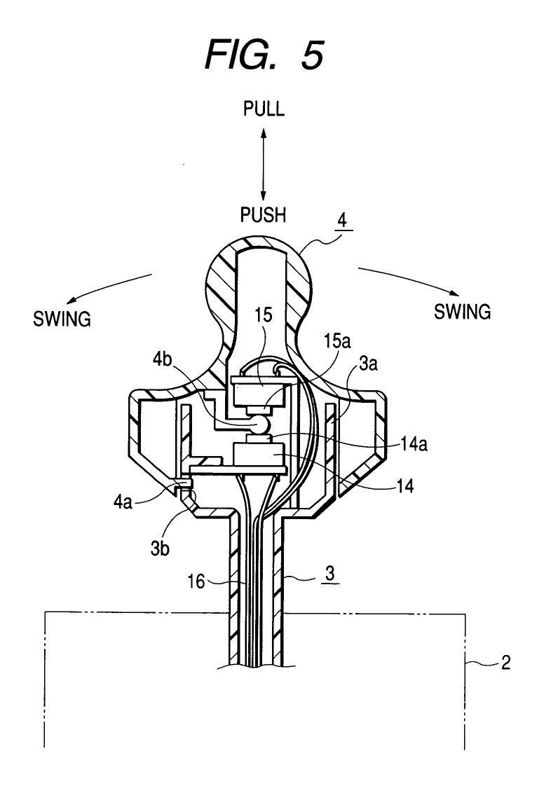

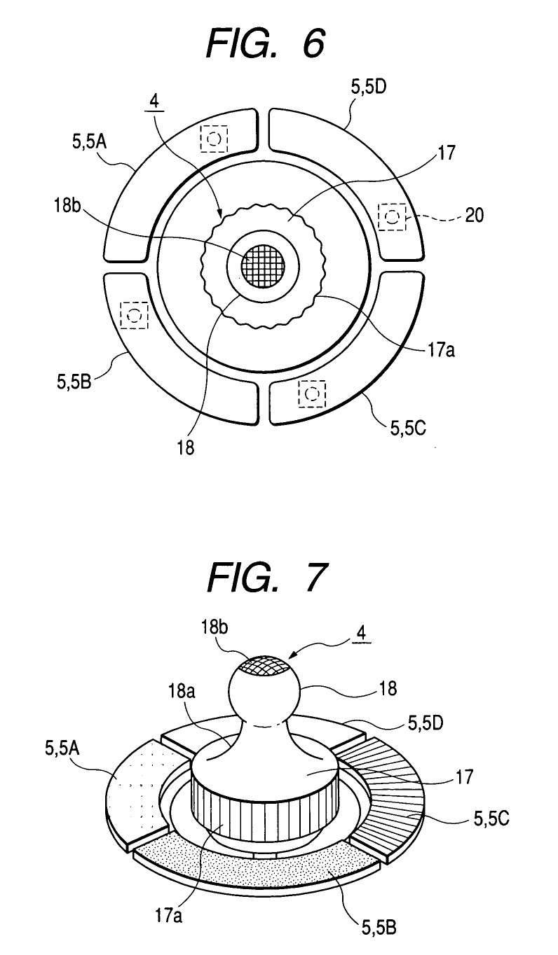

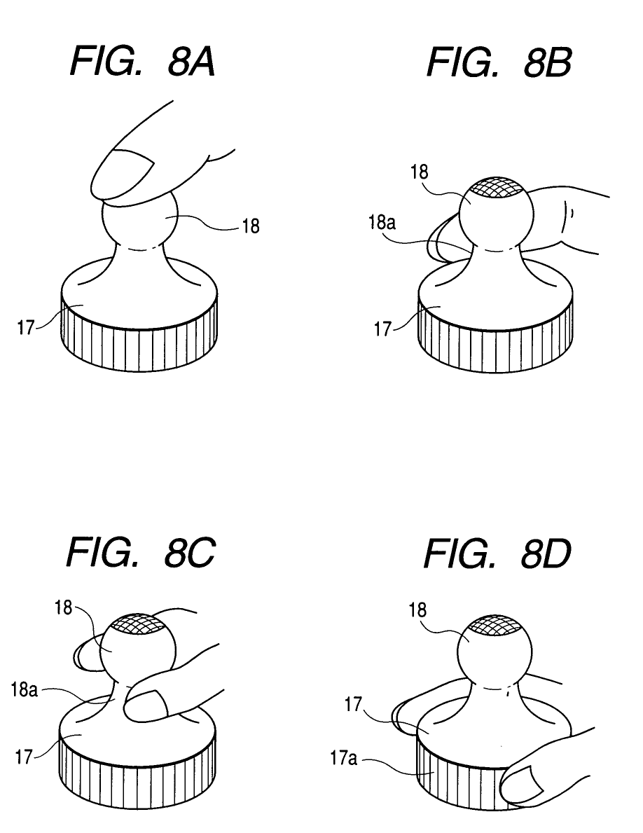

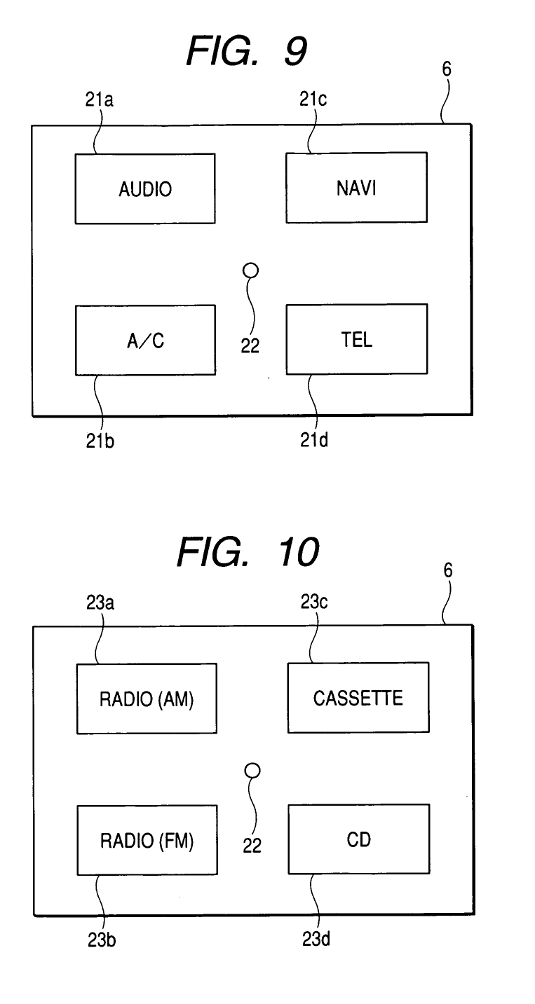

Referring now to the drawings, mode for carrying out the invention will be described. FIG. 1 is a drawing showing a construction of a sense of force imparting type input device according to an embodiment of the present invention; FIG. 2 is a perspective view of a stick controller provided in the sense of force imparting type input device; FIG. 3 is a lateral cross-sectional view of the stick controller; FIG. 4 is a vertical cross-sectional view of the stick controller; FIG. 5 is a cross sectional view showing the internal construction of an operating knob provided in the sense of force imparting type input device; FIG. 6 is a plan view showing the operating knob and a group of the key switches; FIG. 7 is a perspective view showing the operating knob and the group of key switches; FIG. 8 is an explanatory drawing showing an example of operation of the operating knob; and FIG. 9 to FIG. 11 are explanatory drawings showing the contents of display of a monitor.

As shown in FIG. 1, the sense of force imparting type input device according to the present embodiment mainly includes an outer casing 1 having an opening 1a, a stick controller 2 disposed inside the outer casing 1, an operating lever 3 pivotably supported by the stick controller 2, an operating knob 4 attached to the upper end of the operating lever 3, four key switches 5 arranged on the outer casing 1, a control unit 6, and a monitor 7. The outer casing 1 is a panel, for example, of the center console box in the vehicle cabin, and the operating lever 3 projects through the opening 1a of the outer casing 1 into the vehicle cabin.

As shown in FIG. 2 to FIG. 4, the stick controller 2 has a box-shape enclosure 2a, and a pair of revolving bodies 8, 9 are rotatably supported in the enclosure 2a so as to be orthogonal with respect to each other. On two of outer surfaces of the enclosure 2a, which is orthogonal with respect to each other, there are provided motors 10, 11 which serve as actuator, and shafts of the revolving bodes 8, 9 are connected to rotating shafts of the motors 10, 11. Rotary encoders 12, 13 are arranged coaxially with the motors 10, 11 respectively, and the rotating shafts of the motors 10, 11 are connected to the rotor units of the encoders 12, 13. Both of the encoders 12, 13 constitute detecting means for detecting the operating state of the operating lever 3. In other words, the lower end of the operating lever 3 engages the intersecting portions of both of the revolving bodies 8, 9, and thus when the operating lever 3 is pivoted to a corresponding direction, such pivotal movement is converted into the rotary movements of both of the revolving bodies 8, 9, and detected signals according to the amount of pivotal movement and the direction of the pivotal movement of the operating lever 3 are supplied from both of the encoders 12, 13. Each encoder 12, 13 has a restoring spring, not shown, and thus the operating lever 3 is automatically restored to the upright posture by these restoring springs.

As shown in FIG. 5, a storage section 3a is integrally formed at the upper end of the operating lever 3 projected from the opening 1a, and first and second push switches 14, 15 are mounted in the storage section 3a. The first push switch 14 has a stem 14a so that when the stem 14a is pressed against a spring force of the restoring spring, not shown, provided therein, a movable contact point, also not shown, comes into contact with a fixed contact point to turn ON. The second push switch 15 is also constructed in the same manner, and the stems of the first and the second push switches 14, 15 face with each other at a predetermined interval. The first and the second push switches 14, 15 are provided with wire leads 16 connected thereto, and the wire leads 16 are connected to the control unit 6 through the inside of the hollow control lever 3.

The operating knob 4 is fitted onto the storage section 3a of the operating lever 3 so that the operating knob 4 can reciprocate along the axis of the operating lever 3 by sliding on the storage section 3a. However, the extent of the movement along the axis of the operating knob 4 is limited within a predetermined range since a stopper projection 4a of the operating knob 4 is inserted into an engaging hole 3b of the storage section 3a, and simultaneously, the operating knob 4 is prevented from falling off the operating lever 3. The operating knob 4 is provided with a pusher 4b therein, and the pusher 4b is positioned between the stems 14a, 15a of the first and the second push switches 14, 15. Therefore, the operating knob 4 is stably held at the neutral position without being subjected to a load because the pusher 4b is subjected to an urging force, which is uniform in the vertical direction, from the restoring springs integrated in the first and the second push switches 14, 15. Therefore, when the operating knob 4 is pushed with reference to the neutral position, the first push switch 14 is turned ON by the pusher 4b, and when the operating knob 4 is pulled with reference to the neutral position, the second push switch 15 is turned ON by the pusher 4b.

As shown in FIG. 6 and FIG. 7, the operating knob 4 includes a column-shaped large diameter portion 17 located outside the storage section 3a of the operating lever 3 and a protuberant portion 18 projecting upward from the center of the large diameter portion 17, and the protuberant portion 18 has a narrowed portion 18a at the midpoint thereof. The large diameter portion 17 is formed with knurl 17a on the outer peripheral surface thereof, and the protuberant portion 18 is also provided with knurl 18b for providing a roughened surface at the top of the spherical body thereof. Four key switches 5 are arranged generally into an annular shape so as to surround the upper end portion of the operating lever 3 and the operating knob 4. Although all the key switches 5 are formed into the same shape, they are subjected to the surface treatment which gives different surface touches from key to key. When reference numerals 5A to 5D are designated to each of the key switches 5 for convenience's sake, in the case of the present embodiment, a key switch 5A is provided with a mirror finished surface, a key switch 5B is provided with a number of projections, a key switch 5C is provided with fine irregularity formed by etching on the surface thereof, and a key switch 5D is formed with a number of lines by knurling on the surface thereof. As shown in FIG. 1, a circuit board 19 is mounted on the back surface of the outer casing 1, and four push switches 20 facing the respective key switches 5 are mounted on the circuit board 19.

The control unit 6 is provided with a CPU and a memory integrated therein. The CPU receives a detected signal supplied from both of the encoders 12, 13, determines a first control signal corresponding to the detected signal based on data or program stored in the memory, and supplies the first control signal to both of the motors 10, 11. The first control signals are signals corresponding to a feeling of operation imparted to the operating lever 3 and the operating knob 4, and include several types such as a type which generates vibrations, or a type which varies the operating force. When the signal is vibration generating type, the first control signals which represent the intensity of vibrations, the shape of vibrations, the loading time, the frequency, and so on are generated. When the signal is operating force varying type, the first control signals which represent the intensity of the operating force, the direction of generation of the operating force (that is, resistance force or thrust), the loading time, and so on are generated. The control unit 6 is supplied with ON signals for the first and the second push switches 14, 15 and the respective push switches 20, and supplies the second control signal to the monitor 7 according to such ON signals or signals detected by the both of the encoders 12, 13. The second control signals are signals for determining or canceling the action for selecting the equipment or the function displayed on the monitor 7, or for displaying a cursor corresponding to the operating position of the operating lever 3 on the monitor 7. The monitor 7 is disposed in the instrument panel in the vehicle cabin.

Subsequently, referring to FIG. 9 to FIG. 11, the operation of the sense of force imparting type input device arranged as described above will be described.

When a system of sense of force imparting type input device is actuated, as shown in FIG. 9, the equipment menu indicating four options 21a-21d of equipment such as “AUDIO”, “A/C”, “NAVI”, and “TEL”, respectively, and a cursor 22 showing the current position of the operating lever 3 are shown on the monitor 7 as an initial screen. In this case, the operating lever 3 is held in an upright position at the center by restoring spring of both of the encoders 12, 13, and the cursor 22 is positioned substantially at the center of the monitor 7. The equipment menu options 21a-21d correspond to the respective key switches 5(5A-5D), and the contents of the equipment menu options 21a-21d may be displayed on the respective key switches 5 or on the outer casing 1 in the vicinity thereof. The activating operation of the system may be performed, for example, by pressing a start button, not shown, disposed at a predetermined position in the vehicle cabin, or may be performed in conjunction with an accessory mode of the ignition key.

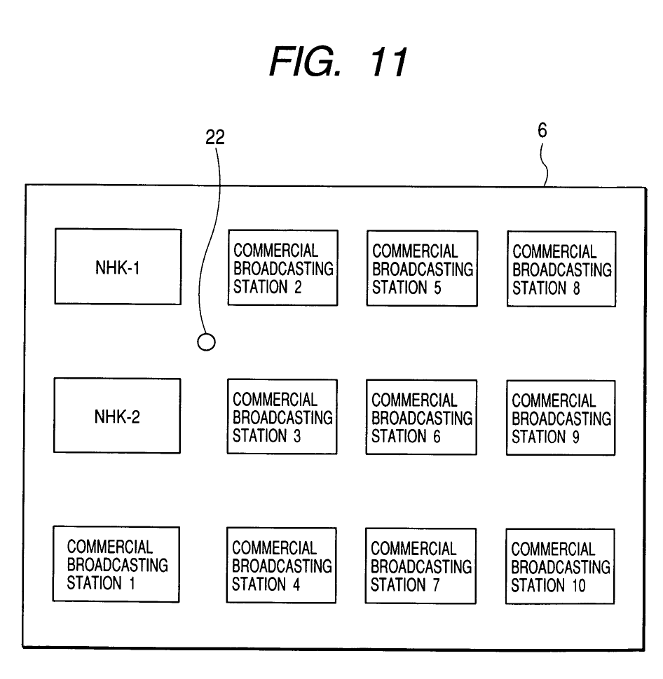

When the operator presses any one of key switches 5 in a state in which the equipment menu options 21a-21d are displayed on the monitor 7, the push switch 20 disposed downwardly of the key switch 5 is turned ON, and the ON signal is input to the control unit 6. Accordingly, the control unit 6 supplies the second control signal to the monitor 7, and the display screen on the monitor 7 is switched to a function adjustment screen for the equipment which corresponds to the pressed key switch 5. For example, when the key switch 5A corresponding to the equipment menu 21a is pressed, selection of the equipment displayed as the equipment menu 21a, “AUDIO” is determined, and then, as shown in FIG. 10, the display screen of the monitor 7 is switched to a menu indicating four options “radio (AM)”, “radio (FM)”, “cassette”, and “CD”, 23a to 23d. The pressing operation of such key switches 5 may be performed by the operator by pressing the top surface of the corresponding key switch 5 with a suitable finger with his/her hand supported on the outer casing 1.

When the operator places his/her finger on the operating knob 4 and pivots the operating lever 3 into one direction in a state in which the display screen of the monitor 7 is switched to the function adjusting screen for the selected equipment, the detected signal supplied from both of the encoders 12, 13 of the stick controller 2 are received by the control unit 6. Then, the control unit 6 supplied the second control signal corresponding to the detected signal to the monitor 7, and the cursor 22 moves to a position corresponding to the current position of the operating lever 3. In association with such movement of the cursor 22, the control unit 6 outputs the first control signal corresponding to the detected signal to both of the motors 10, 11, so that a desired feeling of operation is imparted to the operating lever 3. For example, when the cursor 22 reaches the area of the menu 23a indicating “radio (AM)”, an operating force against the pivoting direction of the operating lever 3 is imparted, and when the cursor 22 enters into the area of the menu 23a, an operating force promoting the pivotal movement of the operating lever 3 is generated. Accordingly, the operator who placed his/her finger on the operating knob 4 can recognize that the operating lever 3 is pivoted to the desired direction by touch. In the case described above, the fact that the cursor 22 reaches the area of the menu 23a is notified by a feeling of clicking, and then the touch that the cursor 22 is drawn into the center of the menu 23a may be recognized.

The operator may perform the pivotal operation of such operating lever 3 through various operating methods by placing his/her finger on various portions of the operating knob 4 with his/her hand supported on the outer casing 1. More specifically, the operation may be performed by pressing his/her finger on the top surface of the protuberant portion 18 as shown in FIG. 8A, by pressing his/her finger on the side surface of the narrowed portion 18a of the protuberant portion 18 as shown in FIG. 8B, by catching the narrowed portion 18a of the protuberant portion 18 with two fingers as shown in FIG. 8C, or by catching the large diameter portion 17 with two fingers as shown in FIG. 8D. In any cases, the operating knob 4 may be operated with his/her hand supported on the outer casing 1. Therefore, the operator can perform the pressing operation of the key switch 5 and the pivotal operation of the operating lever 3 described above continuously by touch, and thus the operability may be enhanced and the usability may be improved. When it is adapted to change the displayed color of the menu 23a in addition to exertion of an external force to the operating lever 3 as described above when the cursor 22 reached the area of the desired menu 23a, the operator can recognize that the operating lever 3 is pivoted to the intended direction not only by a sense of force but also visually.

In this manner, adjustment of the function of the “radio (AM)” that corresponds to the menu 23a is selected by moving the cursor 22 to the center position of the desired menu 23a. However, the selection of adjustment of the function is determined when the operator pushes the operating knob 4 in the direction of the axis of the operating lever 3. In other words, when the operator pushes the operating knob 4, the stem 14a of the first push switch 14 is turned ON by being pushed by the pusher 4b, and the control unit 6 receives the ON signal and supplies the second control signal to the monitor 7. Accordingly, as shown in FIG. 11, when the display screen of the monitor 7 is switched to the menu including options such as “NHK (Japan Broadcasting Corporation)-1”, “NHK-2”, “Commercial Broadcasting Station 1-10”, for example, “NHK-1” is selected as described above by pivoting the operating lever 3, and the operating knob 4 is pushed to determine the selected option, the operator can listen to broadcasting of NHK-1 from the radio in vehicle cabin. Such pushing operation of the operating knob 4 can be performed by pressing his/her finger on the top surface of the protuberant portion 18 as shown in FIG. 8A, by catching and pressing the narrowed portion 18a of the protuberant portion 18 with two fingers as shown in FIG. 8C, or by catching and pressing the large diameter portion 17 with two fingers as shown in FIG. 8D. Any operation may be performed continuously in a state in which the operating lever 3 is pivoted.

When the operator wants to cancel the selected menu by the pivotal operation of the operating lever 3 during the menu selection described above, he/she may pull the operating knob 4 in the direction of the axis of the operating lever 3 to cancel the selected menu. For example, when the menu shown in FIG. 11 is displayed on the monitor 7, and the operating knob 4 is pulled in a state in which the “NHK-1” is selected by moving the cursor 22, the stem 15a of the second push switch 15 is turned ON by being pressed by the pusher 4b, and the control unit 6 receives the ON-signal and supplies the second control signal to the monitor 7. Consequently, the selection of “NHK-1” is cancelled and the display screen of the monitor 7 is returned to the state shown in FIG. 11. Such pulling operation of the operating knob 4 can be performed by pulling up the protuberant portion 18 with the narrowed portion 18a caught by two fingers as shown in FIG. 8C, or by pulling up the large diameter portion 17 with the large diameter portion 17 caught by two fingers as shown in FIG. 8D. In any case, the operator can perform the canceling operation continuously in a state in which the operating lever 3 is pivoted.

Although the case of “selecting a radio station” of the audio set has been described thus far, selection of the function of other equipment can be made through the same basic operation except that the display of the monitor 7 is different. For example, by pressing the key switch 5B and selecting “A/C” from the equipment menu options 21a-21d shown in FIG. 9 and pivoting the operating lever 3, the temperature or the airflow of the air-conditioner can be adjusted.

As described above, since the sense of force imparting type input device according to the present embodiment includes the plurality of key switches 5 arranged to surround the operating lever 3 that is projected from the opening 1a of the outer casing 1 and is adapted to determine the equipment from the equipment menu options 21a-21d displayed on the monitor 7 by pressing a corresponding key switch 5, the operator can perform the pressing operation of the key switch 5 and the pivoting operation of the operating lever 3 continuously by touch with his/her hand supported on the outer casing 1 when selecting the desired equipment from the equipment menu options 21a-21d displayed on the monitor 7 and adjusting the function of the selected equipment, so that the operability is enhanced and the usability is improved. In addition, since the key switches 5 (5A-5D) are subjected to the surface treatment which gives different surface touches from key to key, the operator can distinguish the respective key switches from difference of hand feelings that are noticed when touching the surfaces of the respective key switches 5 without checking the key switches 5 visually.

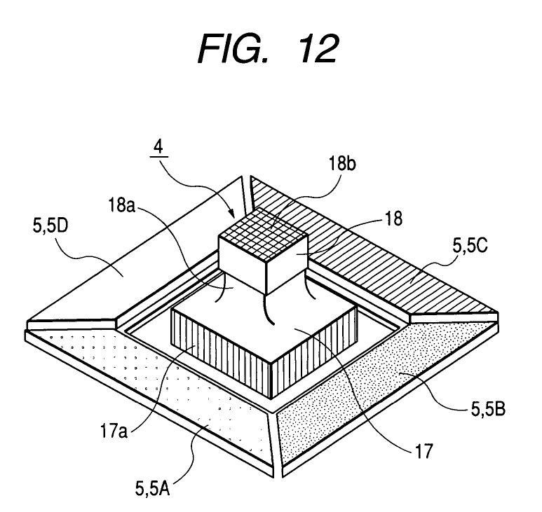

The configuration of the operating knob 4 and the respective key switches 5 are not limited to the embodiment described above. For example, as shown in FIG. 12, four key switches 5 may be arranged in the shape of a square frame. In this case, the operator can recognize the position of the desired key switch 5 from the arranging direction thereof by touch. When one or both of the large diameter portion 17 and the protuberant portion 18 of the operating knob 4 are formed into the shape of a rectangular column, the direction of the operating lever 3 to be pivoted can be recognized from the configuration of the operating knob 4 by touch when the operator places his/her finger on the respective portions of the operating knob 4.

Furthermore, although the case in which the key switches 5 are subjected to the surface treatment which gives different surface touch from key to key to recognize the positions of the respective key switches 5 by touch has been described in the embodiment described above. However, the operator can recognize the positions of the key switches 5 by touch not only by such difference in surface treatment, but also by differentiating at least one of the operating force or the operating stroke of the respective switches 5 from key to key.

In addition, although the case in which the four key switches 5 are arranged around the operating lever 3 has been described in the above-described embodiment, the number of the key switches 5 can be adjusted depending on the equipment menu displayed on the monitor 7, as a matter of course.

When the present invention is embodied according to the embodiment described above, advantages as described below are achieved.

Since the sense of force imparting type input device according to the present embodiment includes the plurality of key switches arranged to surround the operating lever that is projected from the opening of the outer casing and is adapted to determine the equipment from the equipment menu displayed on the monitor by pressing a corresponding key switch, the operator can perform the pressing operation of the key switch and the pivoting operation of the operating lever continuously by touch with his/her hand supported on the outer casing when selecting the desired equipment from the equipment menu displayed on the monitor and adjusting the function of the selected equipment, so that the operability is enhanced and the usability is improved.

What is claimed is:

1. A sense of force imparting type input device comprising: an outer casing having an opening;
an operating lever having a fulcrum inside the outer casing and being pivotably supported;
detecting means for detecting the operating state of the operating lever;
an actuator for imparting an external force to the operating lever;
control means for controlling driving of the actuator based on output signals supplied from the detecting means; and
a monitor for displaying various menus and the current position of the operating lever,
wherein the outer casing is provided with a plurality of key switches arranged thereon so as to surround the operating lever, and the key switches are allocated to a plurality of pieces of equipment displayed as an equipment menu on the monitor, so that the selecting operation of equipment from the equipment menu is determined by pressing the key switches.

2. A sense of force imparting type input device according to claim 1, wherein the key switches are subjected to the surface treatment that gives different surface touches from key to key.

3. A sense of force imparting type input device according to claim 1, wherein the operating forces required to operate the key switches differ from each other.

4. A sense of force imparting type input device according to claim 1, wherein the operating strokes of the key switches differ from each other.

5. A sense of force imparting type input device according to claims 1, wherein the key switches are arranged into an annular shape.

6. A sense of force imparting type input device according claims 1, wherein the key switches are arranged into the shape of a square frame.
